(19) United States
(12) Patent Application Publication
(10) Pub. No.: US 2003/0038177 A1
(43) Pub. Date: Feb. 27, 2003

(54) Passive flash media adapter system

(76) Inventor: Neil Morrow, San Jose, CA (US)

Correspondence Address: Edmund P. Pfleger, Grossman Tucker Perreault & Pfleger, PLLC, 55 South Commercial Street, Manchester, NH, 03101, US

(21) Appl. No.: 10/044,521

(22) Filed: Jan. 10, 2002

Related U.S. Application Data
(60) Provisional application No. 60/314,107, filed on Aug. 21, 2001.

(51) Int. Cl. G06K 7/06

(52) U.S. Cl. 235/441

(57) ABSTRACT

Systems are provided for the enhancement of a host system for microprocessor-based devices. An enhanced PC Card controller is adapted to connect with and/or to exchange information with one or more flash media cards having different media formats, through a passive media adapter. The enhanced PC Card controller determines the presence of one or more flash media cards within an intermediate media adapter, and determines the media format of the media, such that the microprocessor-based device is connected with one or more flash media having different media formats. The multiple format flash media adapter is also provided, which interfaces to flash media cards having different media formats, and provides appropriate connections for each of the media formats. A media bay acceleration system is also provided for microprocessor-based devices, which provides high-speed access to a host system, such as for connected flash media.

### CROSS-REFERENCE TO RELATED APPLICATIONS

This application claims priority to U.S. Provisional Patent Application 60/314,107 filed Aug. 21, 2001 (Attorney Docket No. O2MI0008PR).

### FIELD OF THE INVENTION

The invention relates to the field of PC Card controllers, passive flash media adapters, and media bay systems for microprocessor-based devices. More particularly, the invention relates to enhanced PC Card controllers and media bay systems which support multiple flash media types, and to flash media adapters which enable support for multiple flash media types.

### BACKGROUND OF THE INVENTION

Microprocessor-based devices, such as desktop computers, laptop computers, personal digital assistants (PDAs), and/or mobile phones often comprise a connection to flash media, such as to a Memory Stick™, to a SmartMedia™ card, or to MMC/SD media. Flash media is typically installed within a flash media port, either directly into the microprocessor device, or through an intermediate adapter, having a socket connector. Card detect (CD) signals are very common in socket connectors, to indicate to the system when a card, e.g. such as a Memory Stick™ card, by Sony Electric Co., Inc., has been inserted. For common flash media connectors, the card detect signals, e.g. CD#, are typically active low.

FIG. 1 shows a media adapter system 10 adapted to receive different flash media 20a,20b,20c,20d having different formats. A dedicated Memory Stick™ passive adapter 18a comprises a socket connector 28a to establish contact with corresponding contacts on the Memory Stick™ 20a, and further comprises host, i.e. system, connections 26a to establish contact with a PC card controller 14 through corresponding contacts, such as through a card bay socket interface 16. Similarly, a dedicated SmartMedia passive adapter 18b comprises a socket connector 28b to establish contact with corresponding contacts on the SmartMedia card 20b, and further comprises host connections 26b to establish contact with a PC card controller 14 through a corresponding contact interface 16.

In FIG. 1, an MMC/SD passive adapter 18c comprises a 2-in-1 socket connector 28c, to establish contact with corresponding contacts on either an MMC card 20c or an SD card 20d, and further comprises host connections 26c to establish contact with a PC card controller 14 through corresponding contacts. Since there are only slight differences in the form factor and required software between an MMC card 20c and an SD card 20d, some passive adapters 18c can provide connections to either an MMC card 20c, or to an SD card 20d, without a query process to distinguish the type of connected media card 20c,20d. The functional extensions of SD cards 20d beyond MMC capabilities are provided by a shared protocol which comprises responses from the media in response to requests from the host 12.

Therefore, the PC card controller 14 supports a single flash media 20 through a dedicated passive adapter 18. For example, the PC card controller 14 shown in FIG. 1 supports Memory Stick™ flash media 20a through a Memory Stick™ passive adapter 28a, SmartMedia™ flash media 20b through a SmartMedia™ passive adapter 28b, and either MMC media 20c or SD flash media 20d through a MMC/SD passive adapter 28c.

As seen in FIG. 1, the PC card controller 12 typically supports a single type of flash media 20, e.g. 20a, through a passive adapter 18, e.g. 18a, except for media types that share a command electrical interface, such as for MultiMedia Cards 20c and SD cards 20d.

In the prior art, a signal, e.g. such as an MC_CD# signal, is used to identify when a flash media card 20 is inserted into a dedicated, i.e. format specific, passive adapter 18. While a query mechanism is sometimes used to identify which type of flash media 20 is supported by a connected passive adapter 20, e.g. for a SmartMedia™ adapter 18b, such a query process only provides query values that correspond to a single media type, e.g. corresponding to a SmartMedia™ card 20b and a SmartMedia™ adapter 18b.

While an adapter system 10 as seen in FIG. 1 can be used to interface with flash media 20 having different formats, dedicated adapters 18 are used to interface with flash media 20 respectively. A user who desires to alternatively connect more than one flash media 20, i.e. having different command interfaces, to a host system 12, through a PC Card socket 16, is therefore required to acquire and use multiple passive adapters 18.

While the media adapter system shown in FIG. 1 may provide a query process to conform the type of flash media 20, e.g. 20a, supported by a connected passive adapter 18, such as 18a, such a process is limited to activate only one flash media interface at any time.

After the media 20 has been inserted into the adapter 18, and the MC_CD# signal is asserted, and a SQRYDR signal is typically driven by the PC card controller 14. The SQRYDR signal is used as a voltage source during the query process. After the SQRYDR signal is activated, the SQRYx signals can be read. Therefore, the SQRYx signals are only read one time per MC_CD# assertion. Since there is only one MC_CD# signal in the system 10 shown in FIG. 1, the architecture is limited in that one notification is given that a card is inserted into a passive adapter, with card detect signals that independently notify the host system when cards are plugged into the corresponding sockets. Therefore, only one flash media electrical interface can be activated through the passive adapter 18 at any time.

It would be advantageous to provide card bay architecture which supports a passive adapter that interfaces with multiple flash media types, and provides both card insertion and multiple media format determination. It would also be advantageous to provide a 3-in-1 connector for SD Card, Multimedia™ Card, and SmartMedia™ interfaces.

Furthermore, it would be advantageous to provide a PC card controller which integrates flash media reader technology. Such a system would be a major technological breakthrough. It would also be advantageous to provide a PC card controller which integrates flash media reader technology, which supports a flash media adapter comprising passive componentry. Furthermore, it would be advantageous to provide an PC card controller which integrates flash media reader technology in conjunction with a flash media adapter comprising passive componentry, to minimize the cost of the flash media adapter. Such a system would be a further technological breakthrough.

It would also be advantageous to provide a query process which corresponds with flash media type, in conjunction with a passive adapter that supports more than one type of media, such as by connecting typical CD# signals to SQR5:3 signals (FIG. 7), to indicate the type of media in the socket of a passive adapter.

Socket connectors, such as Yamaichi Series No. FRS001 connectors, provide a 2-in-1 card bay connection to both SmartMedia card 20b and to an SD card 20c. However, while other cards 20, such as MMC cards 20c may physically be inserted into the card socket 28 of such an adapter, an MMC card 20c may become stuck within the card socket. Such adapter connectors are therefore typically sold as 2-in-1 connectors, such that connection to an MMC card 20c is not supported by the adapter. While such adapter connectors are often provided with documentation and/or labeling to warn users that the adapter does not support an MMC card 20c, a user may still mistakenly attempt to connect an MMC card 20c to a host system through such a connector.

It would therefore be advantageous to provide an adapter connector to properly connect MMC flash 20c, in addition to cards having other formats, e.g. such as Memory Stick media 20a, SmartMedia™ 20b, and/or SD cards 20c. The development of such an adapter connector would constitute a major technological advance.

### SUMMARY OF THE INVENTION

Systems are provided for the enhancement of a host system for microprocessor-based devices. An enhanced PC Card controller is adapted to connect with and/or to exchange information with one or more flash media cards having different media formats, through a passive media adapter. The enhanced PC Card controller determines the presence of one or more flash media cards within an intermediate media adapter, and determines the media format of the media, such that the microprocessor-based device is connected with one or more flash media having different media formats. The multiple format flash media adapter is also provided, which interfaces to flash media cards having different media formats, and provides appropriate connections for each of the media formats. A media bay acceleration system is also provided for microprocessor-based devices, which provides high-speed access to a host system, such as for connected flash media.

### BRIEF DESCRIPTION OF THE DRAWINGS

FIG. 1 shows a host system adapted to receive different flash media having different formats, wherein each of the different flash media has a dedicated flash memory adapter;

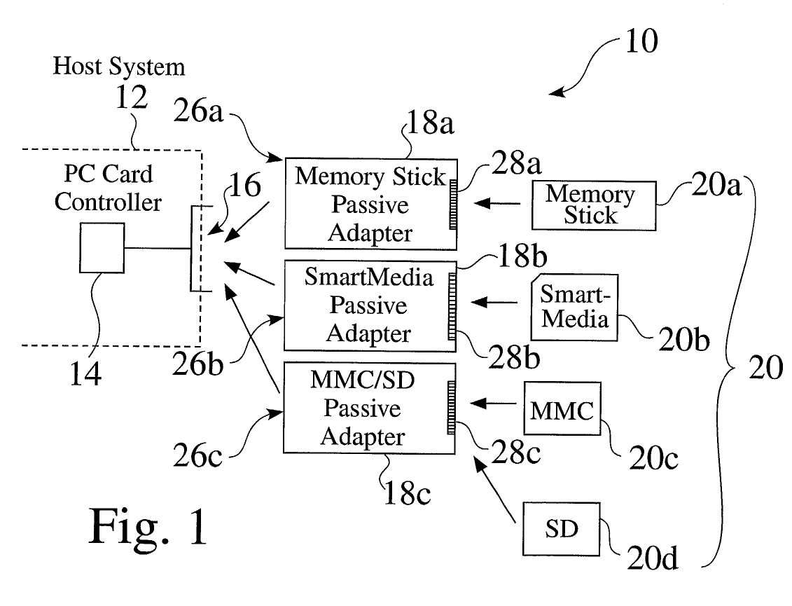

FIG. 2 shows a passive media adapter system having an enhanced PC card controller adapted to receive one or more flash media having different formats through a multi-media passive adapter;

FIG. 3 is a schematic diagram of media card insertion and detection within a multi-media adapter;

FIG. 4 is a schematic diagram of card detection and write protection for flash media;

FIG. 5 is a schematic diagram of card detection for Memory Stick media;

FIG. 6 is a query diagram for a passive flash media adapter system;

FIG. 7 is a query logic table for a passive flash media adapter system;

FIG. 8 is a schematic diagram of a passive adapter for sensing flash media having different formats;

FIG. 9 is a front plan view of a passive adapter for sensing flash media having different formats, comprising a staggered back wall-stop;

FIG. 10 is a top schematic view of a passive adapter for sensing flash media having different formats, comprising a staggered back wall-stop;

FIG. 11 is a side schematic view of a passive adapter for sensing flash media having different formats, comprising a staggered back wall-stop;

FIG. 12 is a side schematic view an incorrectly positioned MMC card within a passive adapter for sensing flash media having different formats, comprising a staggered back wall-stop;

FIG. 13 is a front plan view of a passive adapter for sensing flash media having different formats;

FIG. 14 is a front plan view of an alternate passive adapter for sensing flash media having different formats;

FIG. 15 is a top schematic view of a passive adapter for sensing flash media having different formats, comprising a common back wall-stop;

FIG. 16 is a side schematic view of a passive adapter for sensing flash media having different formats, comprising a common back wall-stop;

FIG. 17 is a side schematic view of card insertion within a passive adapter for sensing flash media having different formats, comprising a common back wall-stop;

FIG. 18 is a functional block diagram of a software stack for an SCB MediaBay system; and

FIG. 19 is a schematic block diagram of SCB MediaBay hardware architecture; and

FIG. 20 is a partial schematic block diagram of an SCB Media Bay system integrated within host hardware architecture.

### DETAILED DESCRIPTION OF PREFERRED EMBODIMENTS

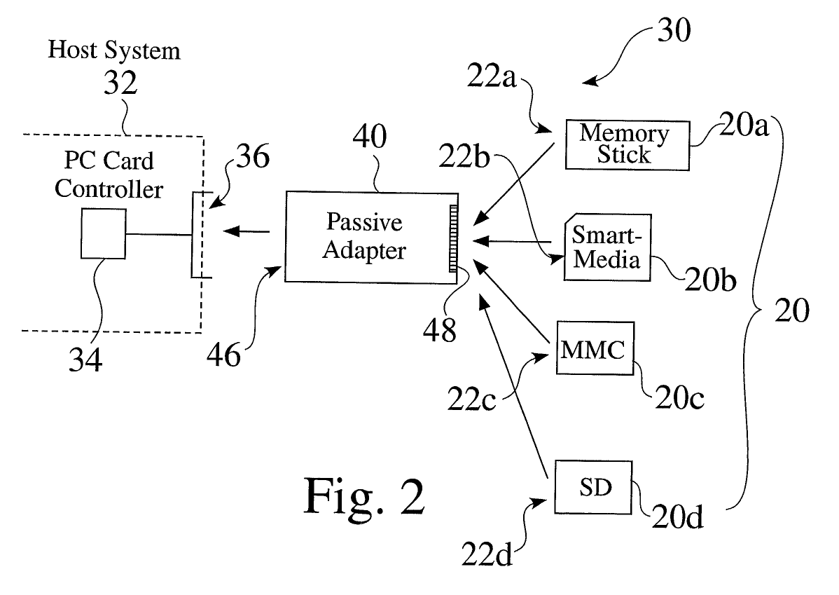

FIG. 2 is a functional block diagram of a passive flash media adapter system 30. A host system 32 comprises an enhanced PC card controller 34, which is adapted to receive one or more flash media 20, such as 20a, 20b, 20c, and 20d, having different formats through a passive adapter 40, which supports one or more media formats.

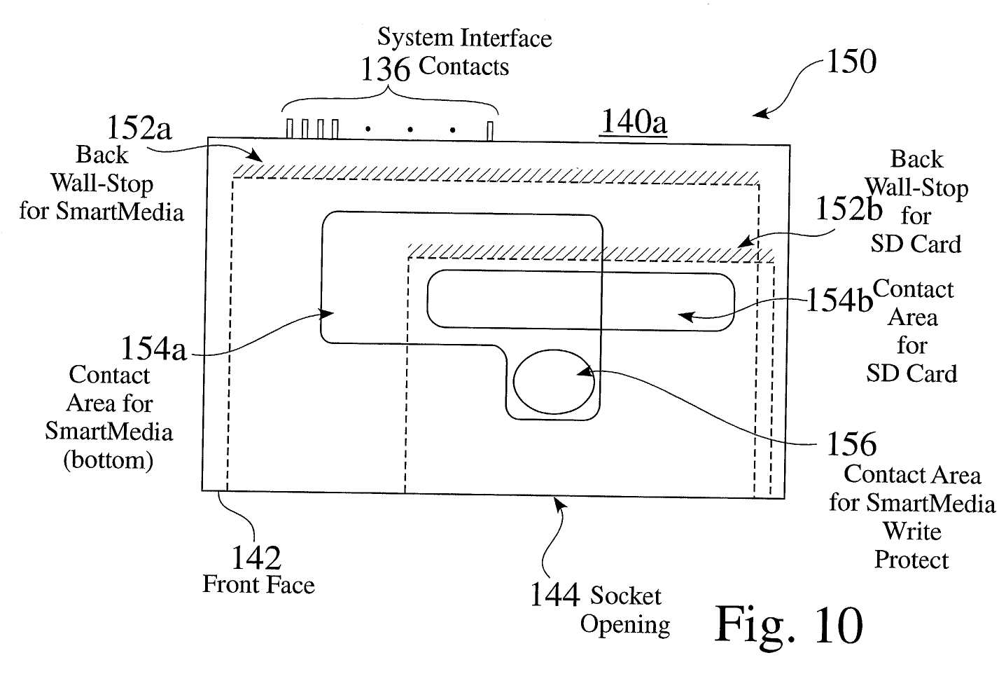

The enhanced PC Card controller 34 supports multiple flash media types 20, e.g. 20a,20b,20c,20d within a single passive adapter 40, such that one or more of the flash media 20 can be electronically and physically connected to the host system 32 at the same time. The multimedia passive adapter 40 shown in FIG. 2 comprises a system connection end 46, having system contacts 136 (FIG. 10-FIG. 17), and one or more media sockets 48, to receive one or more flash media 20. The multimedia passive adapter 40 interacts with the enhanced PC Card controller 34, to communicate card detection information as well as flash media type, such that the enhanced PC card controller 34 determines, i.e. senses, the presence of one or more installed flash media 20, and determines the type of connected flash media 20, e.g. such as a SmartMedia ™ card 20b.

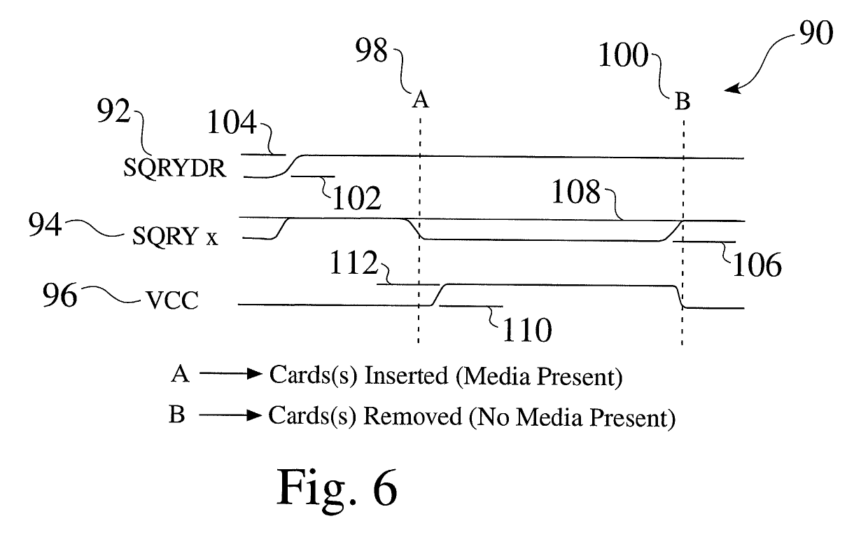

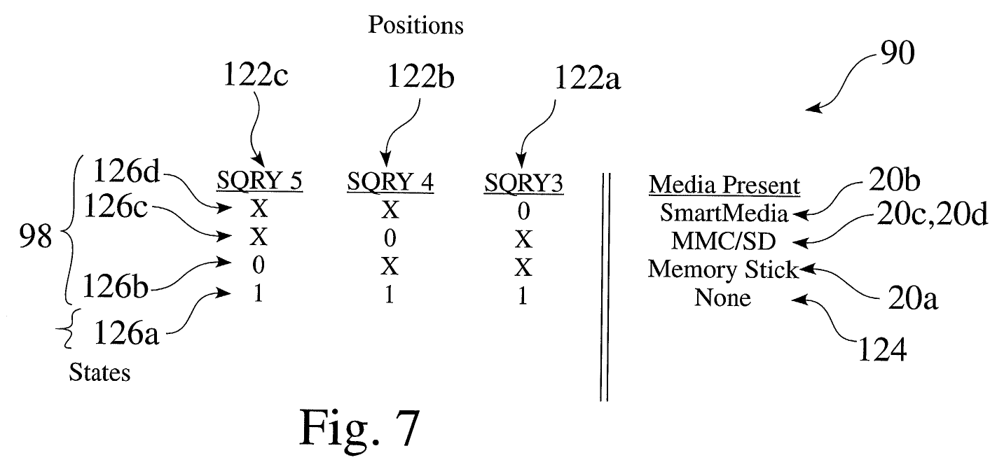

The enhanced PC Card controller process preferably comprises a sensing, i.e. query, step 98 (FIG. 6), to determine that a connected passive adapter 40 supports multiple media types. Once the enhanced PC Card controller 34 determines that multiple media types are supported in the passive adapter 40, the enhanced PC Card controller 34 abandons the query process 98, and performs a media determination process 120 (FIG. 7), to determine which type of media 20, e.g. 20a, is currently connected to the passive multi-media adapter 40, preferably based upon corresponding unique card detect or presence indicator signals.

In some embodiments of the passive multimedia adapter system 30, the enhanced PC Card controller 34 supports access between the host system 32 and one media card 20, e.g. such as a media card 20a, even when more than one media card 20 is present within an adapter 40 which can receive more than one media card 20. For example, when a Memory Stick™ card 20a is inserted in a passive adapter 40 at the same time as a SmartMedia card 20b, the enhanced PC Card controller 40 typically utilizes a priority scheme to connect just one of the media cards 20, e.g. 20a, to the host system 32.

In alternate embodiments of the passive multimedia adapter system 30, the enhanced PC Card controller 34 supports a connection between the host system 32 and more than one media card 20a,20b,20c,20d at the same time. For example, when a Memory Stick™ card 20a is inserted in a passive adapter 40 which can receive more than one media card 20 at the same time as a SmartMedia card 20b, the enhanced PC Card controller 34 may preferably connect both the Memory Stick™ card 20a and SmartMedia™ card 20b to the host system 32 at the same time.

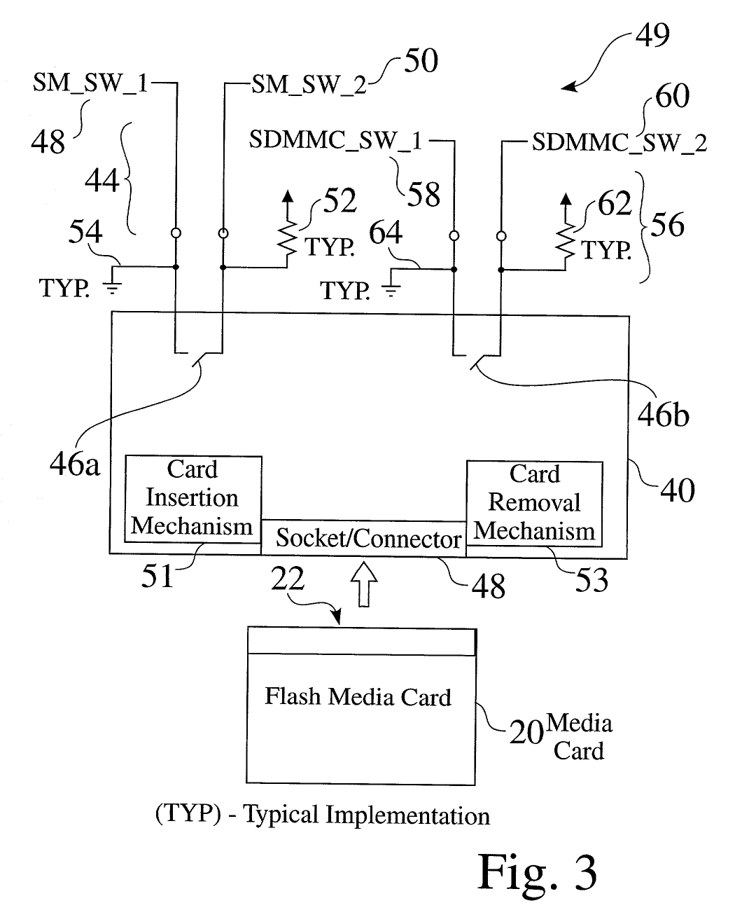

FIG. 3 is a schematic diagram 49 of media card insertion and card detection for a multi-media adapter 40, such as a multimedia 2-in-1 or 3-in-1 multimedia socket adapter 40. In one embodiment of the system 30, the passive multimedia adapter 40 is Part No. FRS001-2000-0 2-in-1 socket, manufactured by Yamaichi Electronics Co., Ltd., of Tokyo, Japan, which supports either a SmartMedia™ card 20b or an SD card 20d. The adapter 40 preferably comprises a card insertion mechanism 51, e.g. such as manual or assisted insertion 51, as well as a card removal mechanism, such as a manual or ejector-type removal mechanism 53.

In the embodiment shown in FIG. 3, SM_SW_{—}2, pin 50, comprises logic level high when no SmartMedia™ card 20b is inserted within socket 48, and comprises logic level low when a SmartMedia™ card 20b, having electrical interface 22b, is inserted within socket 48. Similarly, SDMMC_SW_{—}2 60 is logic level high when no Multimedia card (MMC) card 20c or SD Card 20d is inserted, and is logic level low when either a MultiMedia card 20c or an SD Card 20c is inserted. While MultiMedia cards (MMC) 20c and SD media cards 20d are different card types, MultiMedia cards (MMC) 20c and SD media cards 20d share a common electrical interface 22c.

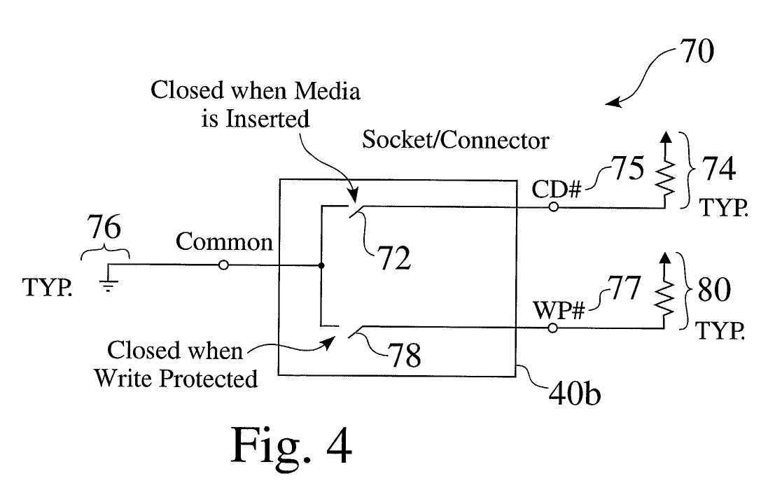

FIG. 4 is a schematic diagram 70 of card detection circuitry 75 and write protection circuitry 77 for a single media socket adapter 40 that utilizes a common logic level to indicate card insertions and write protection, such as a Part No. FPS009-3000, available through Yamaichi Electronics Co., Ltd., of Tokyo, Japan. In FIG. 4, card detect CD 75, typically acting through a switch 72 and circuitry 74 to a ground 76, is logic level high when no card 20 is inserted, and is logic level low when a card 20 is inserted. Similarly, write protect 77, typically acting through a switch 78, circuitry 80 to ground 76, is logic level high when no write protection is activated on the connected media 20, and is logic level low when the flash media 20 is write protected. As seen in FIG. 4, the card detection circuitry 75 is functionally equivalent to the card detection circuitry 49 shown in FIG. 3.

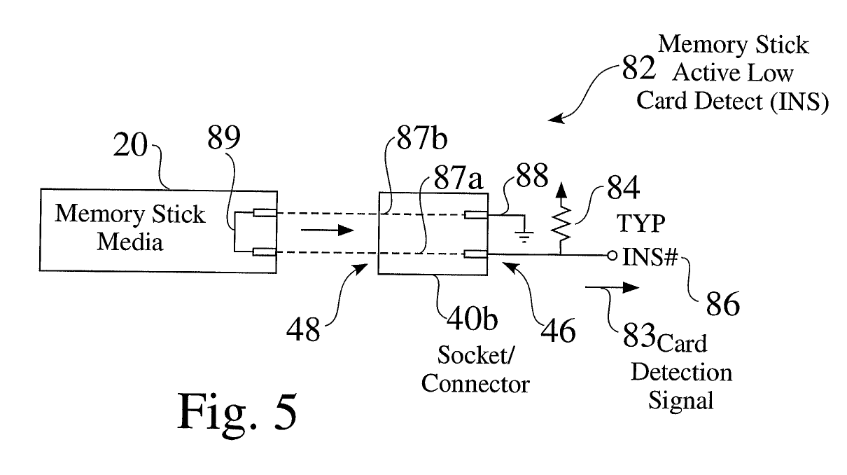

FIG. 5 is a schematic diagram 82 of card detection for Memory Stick™ media 20a. In the passive multimedia socket adapter 40b shown in FIG. 5, a mechanical switch, such as card detect switch 72 (FIG. 4) is not required. When Memory Stick™ flash media 20a is inserted into the passive multimedia adapter 40b, the INS signal 86, typically connected to a potential through circuitry 84, is directly connected to the GND signal 88, typically through adapter paths 87a,87b and flash media connection 89, providing an active low card detection signal 83, via INS 86, in a manner similar to the card detection shown in FIG. 3 and FIG. 4. In one embodiment of the passive multimedia adapter 40b shown in FIG. 5, the passive multimedia adapter 40b is a Part No. 68156, available through Molex, Inc., of Lisle, Ill. In an alternate embodiment of the passive multimedia adapter 40b shown in FIG. 5, the passive multimedia adapter 40b is a DUO™ connector, available through Yamaichi Electronics Co., Ltd.

FIG. 6 is a query diagram 90 for a passive flash media adapter system 30. A SQRYDR query signal 92 is controlled between a first state 102 and a second query state 104. SQRY x signals are sampled between a first state 106 and a second state 108. A media supply voltage VCC has a first state 110 and a second state 112. As seen in FIG. 6, the enhanced PC card controller 34 continuously asserts SQRYDR 92, and samples SQRYx 94, to determine insertion events of one or more media 20. During the query process 90, the MC_CD# signal is typically ignored. Once the adapter-sensing step 98 is complete, i.e. when the enhanced PC card controller 34 determines that a flash media 20 is present, at Point A, the enhanced PC card controller 34 determines whether the connected passive adapter 40 supports multiple media types 20, e.g. such as 20a,20b,20c,20d. Similarly, as seen in FIG. 6, enhanced PC card controller 34 can determine when connected media 20 are removed 100, at Point B, based upon the query states.

FIG. 7 is a query logic table 120 for card sensing within a passive flash media adapter system 30. Active low card detect signals for SmartMedia 20b, MMC/SD media 20c,20d, and Memory Stick™ media 20a are respectively wired to SQRY3 122a, SQRY4 122b, and SQRY5 122c. The enhanced PC Card controller 34 samples SQRY5:3, to determine media card insertions into the passive adapter 40. As seen in FIG. 7, a logic state 126d indicates corresponding active low card detect signals for SmartMedia™ 20b. Logic state 126c indicates corresponding active low card detect signals for either an MMC card 20c or an SD card 20d. Logic state 126b indicates corresponding active low card detect signals for a Memory Stick™ 20a. Logic state 126a corresponds to query positions 122a,122b,122c which indicate that no media 20 is present 124.

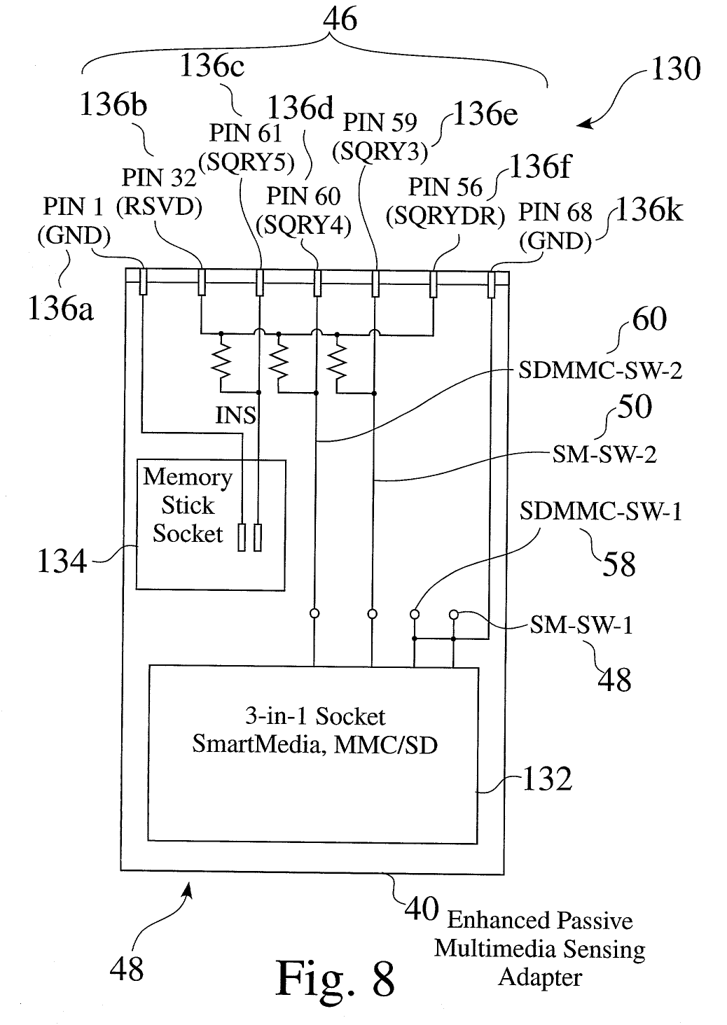

FIG. 8 is a schematic diagram 130 of a passive adapter 40 for sensing flash media having different formats 20, which provides multimedia sensing between the enhanced PC card controller 34 and flash media 20. The passive multimedia adapter 40 comprises a plurality of system interface, i.e. card bay, pins 136a-136k within a system connection region 46. In the exemplary embodiment shown in FIG. 8, Pin 1 136a is a ground GND, Pin 2 is RSVD pin 136b, pin No. 61 is SQRY5 136c, Pin No. 60 is SQRY pin 136d, Pin No. 59 is SQRY3 136e, Pin No. 56 is SQRYDR 136f, and Pin No. 68 is a ground GND 136k. The passive adapter 40 also comprises a Memory Stick™ socket 134, for connection to Memory Stick™ media 20a, and a 3-in-1 socket 132, to connect to any of SmartMedia 20b, MMC media 20c, and/or SD media 20d.

The multi-media sensing process comprises the steps of adapter-sensing 98 and card-sensing 120. The passive adapter 40 shown in FIG. 8 preferably comprises 3-in-1 socket 132, which can be used as an interface between the enhanced PC card controller 34 and a variety of flash media 20 having different formats, such as an SD card 20d, a MultiMedia card 20c, or a SmartMedia card 20b.

Adapter-Sensing Process. The enhanced PC Card controller 34 identifies the presence of a card bay card, such as a passive multimedia adapter 40 or other types of card bay cards, within a card bay port 36. The enhanced PC Card controller 34 preferably identifies the presence of a card bay card, based upon corresponding unique card detect or presence indicator signals. The enhanced PC card controller 34 determines whether the inserted card bay card is a passive multimedia adapter 40. In one embodiment of the enhanced PC Card controller 34, the enhanced PC card controller 34 asserts Pin (A25//CAD19//SQRYDR) 136f, e.g. such as at Pin No. 56 shown in FIG. 8, and samples the input to the PC card interface pin 32 (D2//RFU//RSVD) 136b. If the PC card interface pin 136b sample returns a logic high value (One), the PC card controller 34 determines that the card bay card is a passive adapter 40 adapted to support multiple media types 20 within a single adapter 40. If the PC card interface pin 136b sample returns a logic low signal (Zero), the enhanced PC card controller 34 determines that the card bay card is not a passive adapter 40, and is not adapted to support multiple media types 20 within the passive multimedia adapter system 30.

In some system embodiments, the passive adapter 40 is preferably designed to connect the SQRYDR signal 136f, i.e. Pin 56, directly to Pin 32 (D2//RFU//RSVD) if it is consistent with this invention, as shown in FIG. 8. All other CardBay cards implement Pin 32 as a ground signal, such as through ground pin 136a or ground pin 136k, i.e. logic level low.

The adapter-sensing process 98 generally provides a sensing mechanism such that the enhanced PC Card controller 34 is notified that a passive adapter 40 that supports multiple media types 20 is inserted into the socket 44,132,134. The adapter-sensing process 98 may alternately be performed in ways other than the preferred embodiment described above. For example, a different PC Card interface pin 136 may be sampled to sense the presence of a media card 20c.

As seen in one embodiment of the card-sensing process 98 shown in FIG. 6, the SQRYDR signal 92 is activated 104, and is used as the high logic level source for card detection circuitry on the passive adapter 40. Once the enhanced PC Card controller 34 determines through adapter-sensing 98 that a passive multimedia adapter 40 has been inserted that is consistent with the passive multimedia adapter system 30, the enhanced PC card controller 34 abandons the query process 98 and performs a card-sensing scheme 120, to determine the type of one or media 20 which are connected to the passive adapter 40.

The card sensing process 120 shown in FIG. 7 utilizes an active low card detect signals from SmartMedia sockets, MMC/SD sockets, and Memory Stick sockets that are interfaced with the enhanced PC Card controller 34, via SQRY3, SQRY4, and SQRY5 (Pin 59, Pin 60, Pin 61) respectively. The SQRY5:3 query indicates the presence of media 20. The enhanced PC Card controller 36 continually samples the SQRY5:3 signals after the adapter-sensing process 98 is completed, to determine the presence of flash media 20, ignoring the MC_CD# signal.

Since more than one media type can be implemented by sampling SQRY5:3, the PC Card controller 34 can be further enhanced to activate multiple electrical interfaces to connect multiple media cards 20 to the host system 32 at the same time.

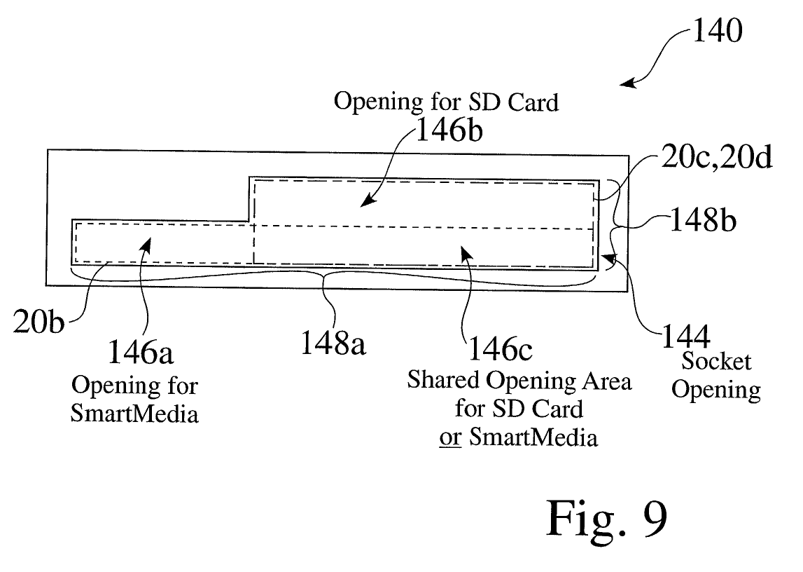

Passive MultiMedia Adapters. FIG. 9 is a front plan view of a passive adapter 140 for sensing flash media 20 having different formats 20b,20d, comprising a staggered back wall-stop 152a,152b (FIG. 10). A common card socket 144 located on the front face 142 (FIG. 10) comprises a plurality of socket regions 146a,146b,146c, wherein a SmartMedia card 20b may be connected to the passive adapter 140, within regions 146a and 146b, since the combined width 148a of the socket opening 144 within regions 146a and 146c provides access for a SmartMedia card 20b. An SD card may alternately be connected to the passive adapter 140, within regions 146b and 146c, since the combined height 148b of the socket opening 144 within regions 146b and 146c provides access for an SD card 20d.

The passive adapter 140 is considered to be a 2-in-1 connector, since the adapter 140 allows any one of two flash media types 20b,20d to properly interface to the system 12,32 at any time through the single adapter 140. In one embodiment, the passive adapter 140 is a Series FRS001 adapter, available through Yamaichi Electronics Co., Ltd. Alternate embodiments of the passive connector 140 comprise a variety of insertion and removal mechanisms. For example, a Yamaichi FRS001-2000-0 connector 140 comprises a push/push type insertion and removal system, a Yamaichi FRS001-2100-0 connector features manual card insertion and removal, and a Yamaichi FRS001-2200-0 connector 140 features ejector-type card removal. While a Yamaichi FPS009-3003 connector features manual card insertion and removal the FPS009-3003 connector does not provide an opening for a SmartMedia card 20b.

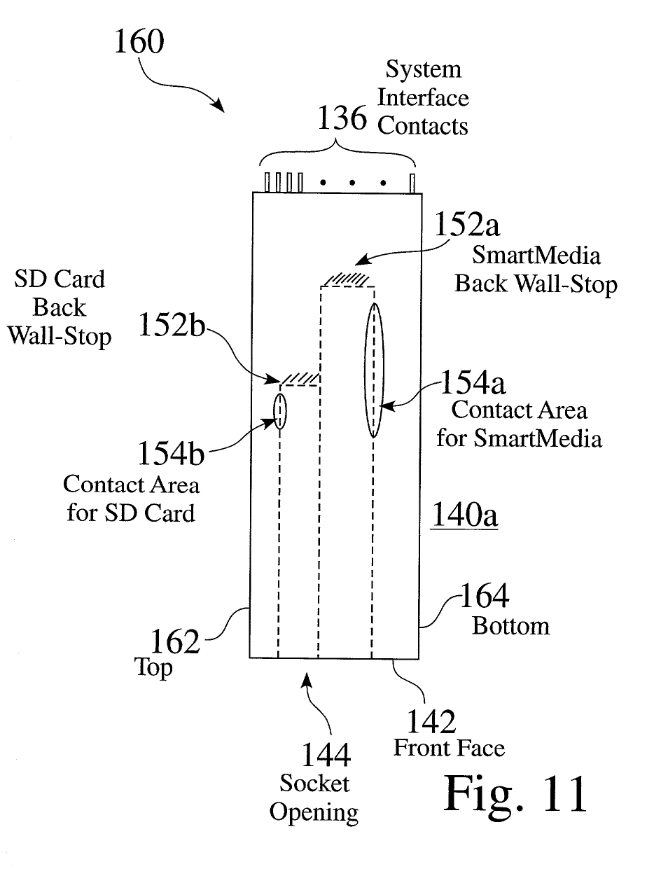

FIG. 10 is a top schematic view 150 of a passive adapter 140 for sensing flash media 20 having different formats 20b,20d, comprising a staggered back wall-stop 152a,152b. FIG. 11 is a side schematic view 160 of a passive adapter 140 for sensing flash media having different formats 20, comprising a staggered back wall-stop 152a,152b. The passive adapter 140 comprises a first contact area 154a, near the bottom 164 of the adapter 140, for connection to a SmartMedia™ card 20b, and a second contact area 154b, near the top 162 of the adapter, for connection to an SD card 20d. The passive adapter 140 also comprises system interface contacts 136, to provide a connection between flash media 20b or 20b to a hot system 12,32, through contact areas 152a or 152b.

In some embodiments of the passive adapter 140, the common card socket 144 provides an opening sufficient for any of a SmartMedia card 20b, an MMC card 20c, or an SD card 20d to be inserted into the card socket opening 144. The wall-stops are positioned in this connector 140 such that a fully, properly inserted SD Card 20d or SmartMedia card 20b will similarly extend out from the front face 6.2 mm.

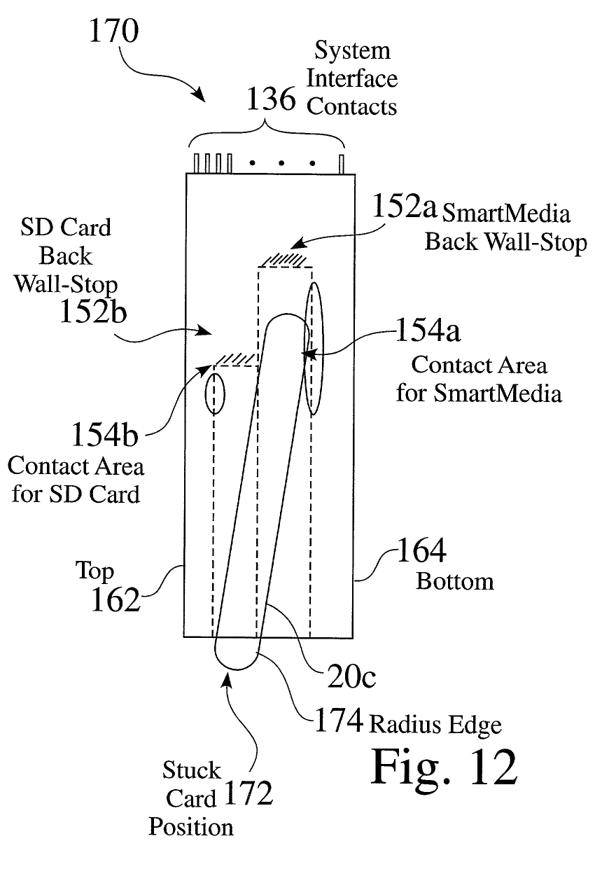

FIG. 12 is a side schematic view 170 of an incorrectly positioned 172 MMC card 20c within a passive adapter 140 for sensing flash media 20 having different formats 20b,20d, comprising a staggered back wall-stop 152a,152b. MMC cards 20c are nominally thicker than the SmartMedia™ opening 146a,146c for a passive adapter 140. As well, MMC cards 20c are typically manufactured with a curved edge 174, whereby an MMC card 20c can problematically be stuck 172 in the passive adapter 140, such as when an MMC card 20c is firmly inserted. A firm MMC insertion may also cause a widening of the SmartMedia opening near the back SD card wall-stop 152b 20d, further enabling a stuck position 172 of an incorrectly inserted MMC card 20c.

Since MMC cards 20c can be incorrectly inserted 172 within such passive adapters 140, as seen in FIG. 12, the use of an MMC card 20c is not supported, and passive adapters 140 are marketed and sold as a 2-in-1 connector 140, to connect to only a SmartMedia card 20b or to an SD card 20d. However, since the form factor, i.e. the size and contact regions of an MMC card 20c appear to interface to the combined socket 144, existing adapters 140 typically include labeling and/or documentation to prevent users from placing MMC cards 20c into the socket 144.

As warning labels do not always prevent users from plugging MMC cards into the 2-in-1 socket 144, the stuck position 172 of an installed MMC card 20c often results in end-user frustration, troubleshooting time, as well as customer support costs to the system provider.

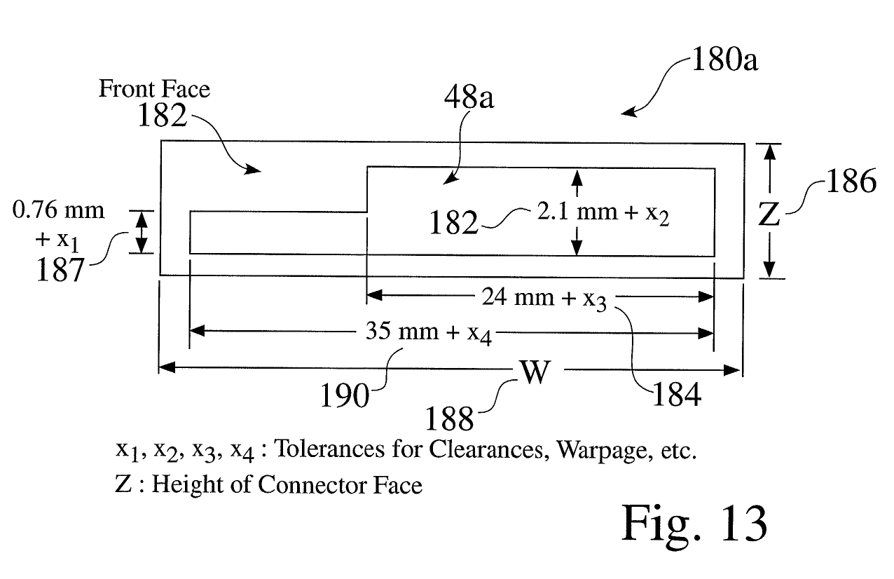

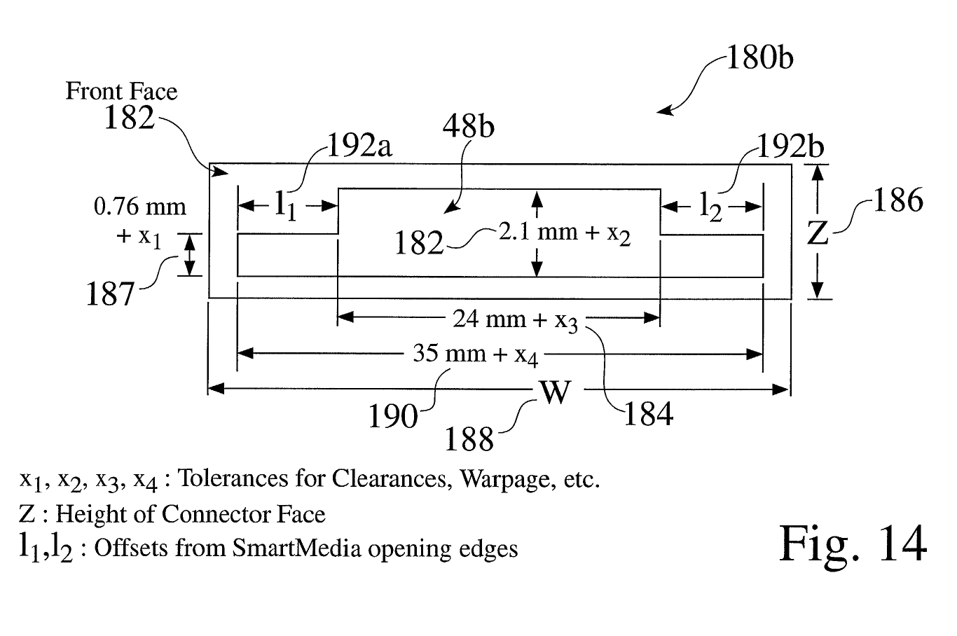

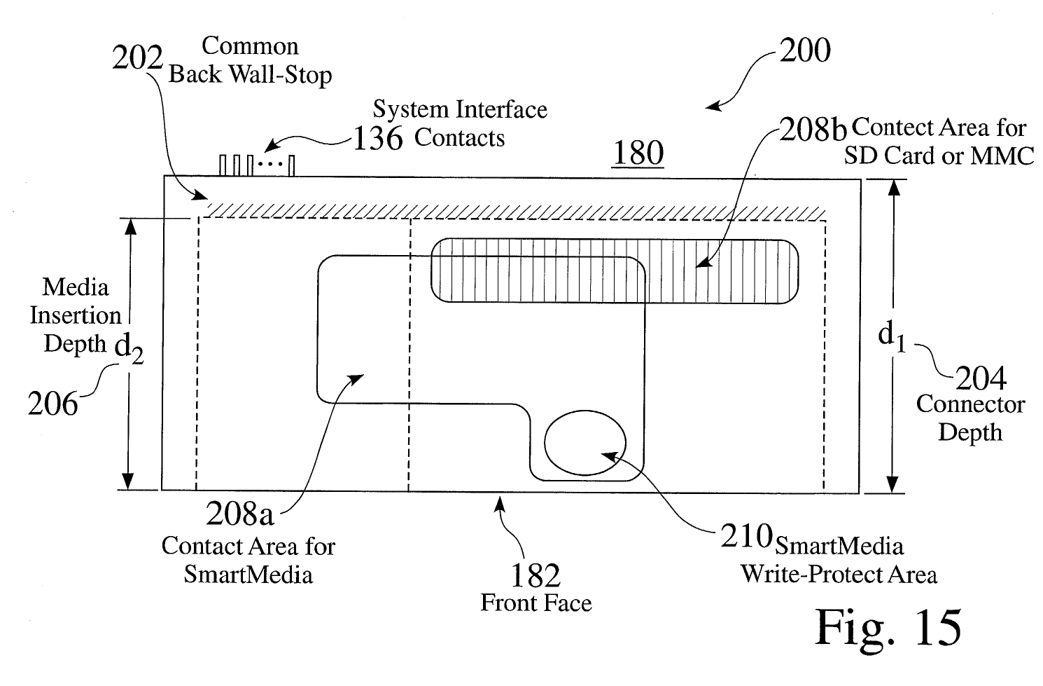

Improved Passive Adapter. FIG. 13 is a front plan view of a multiple format flash media adapter 180a for sensing flash media having different formats 20b,20c,20d. FIG. 14 is a front plan view of an alternate multiple format flash media adapter 180b for sensing flash media having different formats 20b,20c,20d. The front face 182 shown in FIG. 13 and FIG. 14 has a height Z 186 and a width W 188. A socket 48 is defined into the multiple format flash media adapter 180a, extending inward from the front face 182, to a media insertion depth 205 (FIG. 15). In cross-section, the socket 48a shown in FIG. 13 comprises an overall socket height 182, typically corresponding to an insertion height of either an MMC card 20c or an SD card 20d, and overall socket width 190, typically corresponding to an insertion width of a SmartMedia™ Card 20b. The socket 48a also comprises a secondary width 184, typically corresponding to an insertion width of either an MMC card 20c or an SD card 20d, and a secondary height 187, typically corresponding to an insertion height of a SmartMedia™ Card 20b. The dimensions of the socket opening the 3-in-1 multiple format flash media adapters 180a, 180b shown in FIG. 13 and FIG. 14 are preferably based upon the card dimensions for a SmartMedia™ card 20b (35 mm×45 mm×0.76 mm), the card dimensions for an SD Card 20d (24 mm×32 mm×2.1. mm), and the card dimensions for an MMC card 20c (24 mm×32 mm×1.4 mm).

The socket 148b in FIG. 14 further comprises socket opening offsets 192a,192b, such that the region defined for insertion of either an MMC card 20c or an SD card 20d is generally located in the central region of the socket opening 48. The socket 148b in FIG. 14 provides a secure fit on both left and right sides of inserted SmartMedia™ cards 20b, to guarantee appropriate contact to the SmartMedia™ contact area 208a (FIG. 15).

Alternate embodiments of the socket 48 provide a variety of configurations for the opening areas for media having different formats 20, such as media formats 20b,20c,20d. For example, the SmartMedia™ opening may alternately be located closer to the top 212 of the front face, such that there is opening area for an SD Card 20d or an MMC card 20c “below” the opening for a SmartMedia™ card 20b. As well, alternate embodiments of the socket 48 provide a variety of connector face heights 186, clearance tolerances, and card warp-edge tolerances, typically based upon the intended implementation.

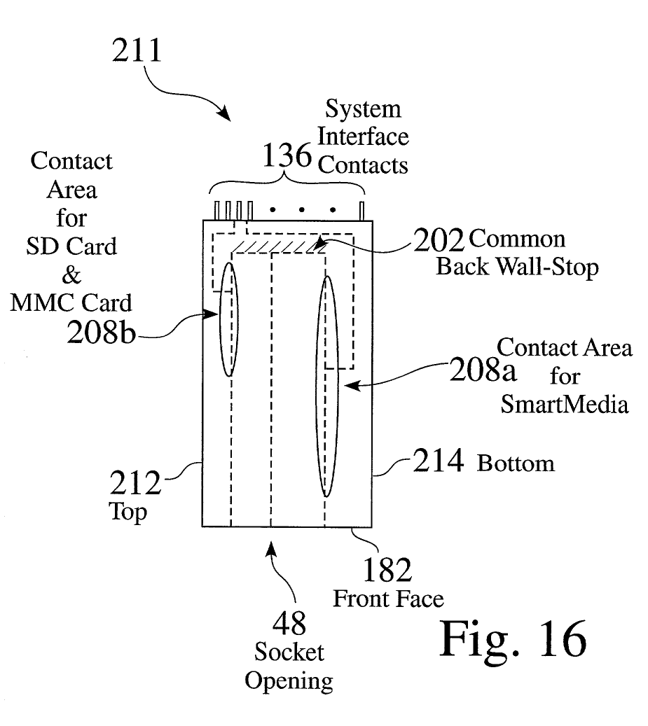

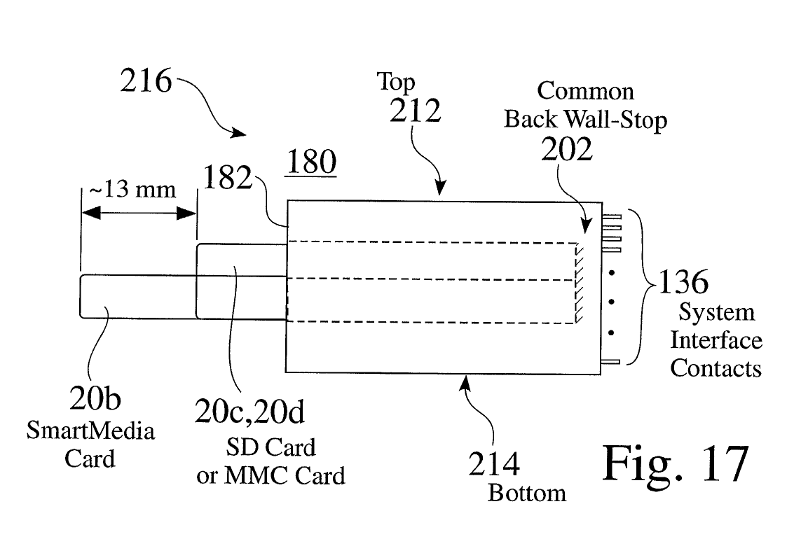

The multiple format flash media adapter 180 provides a common back wall 202 (FIG. 15, FIG. 16, FIG. 17), which provides a reliable connection to wide variety of digital flash media cards 20, comprising any of a SmartMedia card 20b, an MultiMediaCard (MMC) 20c, or an SD Card 20d.

FIG. 15 is a top schematic view 200 of a multiple format flash media adapter 180 for sensing flash media having different formats 20b,20c,20d, comprising a common back wall-stop 202. FIG. 16 is a side schematic view 211 of a multiple format flash media adapter 180 for sensing flash media having different formats 20b,20c,20d, comprising a common back wall-stop 202. FIG. 17 is a side schematic view 216 of card insertion within a multiple format flash media adapter 180 for sensing flash media having different formats 20b,20c,20d, comprising a common back wall-stop 202. The multiple format flash media adapter 180 interfaces to a wide variety of digital flash media cards 20, comprising any of a SmartMedia™ card 20b, an MultiMediaCard (MMC) 20c, or an SD Card 20d. The multiple format flash media adapter 180 provides robust connections between a flash media card 20b, 20c, or 20d and a electronic system, such as a host system 32, through a common socket opening 48.

The multiple format flash media adapter 180 provides a reliable 3-in-1 socket design 48, which successfully interfaces to flash media cards 20b,20c,20d, and provides appropriate connections for each of the media formats. In the flash media adapter 140 seen in FIG. 12, a staggered back wall 152a,152b inherently allows a stuck position 172 of an MMC card 20c under the back-wall 152a,152b. In contrast, as seen in FIG. 15, FIG. 16, and FIG. 17, the common back wall 202 of the multiple format flash media adapter 180 is shared for all media 20b, 20c, or 20d. The common, shared back wall-stop 202 for all insertable media 20b, 20c, 20d prevents media 20, such as an MMC card 20c, from being improperly positioned or stuck 172 within the connector 180.

Alternate embodiments of the multiple format flash media adapter 180 provide a variety of connector depths and/or common wall-stop depths, i.e. the media insertion depth, based upon the implementation. In some preferred embodiments of the multiple format flash media adapter 180, the media insertion depth is sufficiently large to provide connection to the SmartMedia write-protect area 210 (FIG. 15).

As seen in FIG. 15 and FIG. 16, the SmartMedia™ contact area 208a is generally located near on the bottom 214 of the socket 48, while the SD Card and MMC contacts 208b are generally located on the top 208 of the socket 48. Alternate embodiments of the multiple format flash media adapter 180 provide appropriate contact areas 208 to correspond to the flash media 20. For example, for embodiments of the multiple format flash media adapter 180 in which the opening for either an SD Card 20d or an MMC card 20c is “below” the SmartMedia opening 208a, then the contact area 208b for SD Card and MMC cards 20 is typically located on the bottom 214 of the socket 48.

The multiple format flash media adapter 180 shown FIG. 17 allows one type of media to be inserted within the socket 48 at any one time. An inserted SmartMedia™ card 20b extends further from the front face of the socket 48 than an inserted SD Card 20d or MMC card 20c, due to depth of the common wall-stop 202. For example, since a SmartMedia™ card 20b is 45 mm in length, and both an SD Card 20d and an MMC card 20c are 32 mm in length, a SmartMedia card 20b extends approximately 13 mm further from the front-face 182 than either an SD Card 20d or an MMC card 20c.

The multiple format flash media adapter 180 alternately comprises a wide variety of insertion mechanisms 51 and removal mechanisms 53 (FIG. 3), such as but not limited to push/push operation, manual insertion and removal operation, or for ejection removal operation. Furthermore, alternate embodiments of the multiple format flash media adapter 180 comprise a variety of socket depths, media insertion depths, front face designs, and/or contact positions. As well, alternate embodiments of the multiple format flash media adapter 180 readily provide similar connections for other installable media or devices.

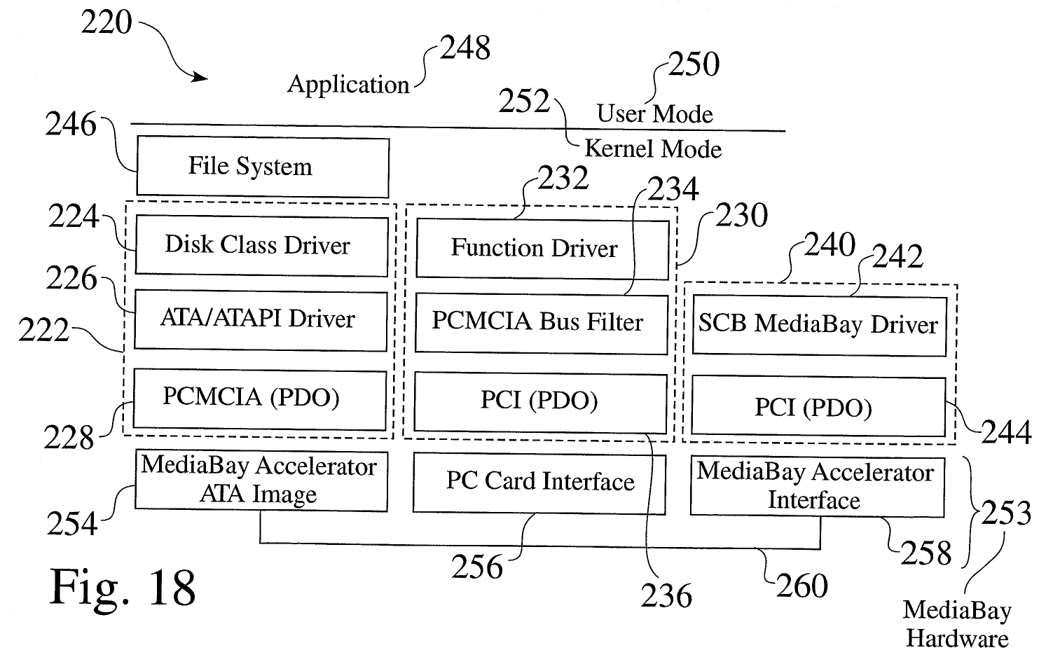

Media Bay Accelerator. FIG. 18 is a functional block diagram 220 of a software stack which illustrates how SCB Media Bay Accelerator driver software 242 is integrated within an operation system storage stack, such as for a Windows™ operating system, by Microsoft, Inc., of Redmond, Wash. Operating systems keep track of resources, such as I/O ports, IRQ interrupts, and associated low-level device drivers, which are associated with hardware components within a PC system. The structure which comprises these entries is typically referred to as a hardware tree. An entry within the hardware tree is typically referred to as a device node.

As seen in FIG. 18, a first device node 222 comprises a disk class driver 224, an ATA/ATAPI driver 226, and a PCMCIA (PDO) driver 228. A physical device object (PDO) typically describes the individual hardware components for which a resource requirements list is maintained within the hardware tree. Therefore, there is a one-to-one relationship between the PDO driver 228 and the device node 222.

The bus drivers 228,236,244 are associated with communication with the hardware components. For example, communication with the Media Bay accelerator ATA image 254 is provided through PCMCIA mechanisms. However, since the PCMCIA bus controller hardware connects to the system through the PCI bus, the PCMCIA management software 234 uses PCI mechanisms to communicate with the hardware register interface 256 which controls PCMCIA plug-and-play connectivity 256.

A second device node 230 comprises a function driver 232, a PCMCIA bus filter 234, and a PCI(PDO) 236. A third Media Bay accelerator device node 240 comprises the smart card bus (SCB) MediaBay Accelerator driver 242, as well as a PCI pin device object (PDO) 244.

As seen in FIG. 18, the Media Bay accelerator hardware 253 comprises a Media Bay accelerator ATA Image 254, a PC Card interface 256, a Media Bay accelerator Interface 258, and associated Media Bay hardware connections 260. While the Media Bay accelerator system 270 comprises hardware 253, the functionality of the Media Bay accelerator system 270 is preferably implemented as an enhancement to the existing microprocessor, PC card controller, and hardware of a host system 34.

The enhanced SCB Media Bay PC Card controller 34 connects to the PCI bus, preferably as a logic PCI device Function 0. The PCI bus driver 228, which is implemented through hardware components in the host chipset, enumerates this physical device object, and determines that the object is a PCMCIA controller, the bus driver loads the PCMCIA bus filter 234 and function driver 232 that provides PCMCIA services, as well as power management for the SCB MediaBay PC controller functions. In one embodiment, the second device node 230, e.g. such as the device node of the OZ711Ex, is embedded within the SCB MediaBay chip 34, which includes the Media Bay accelerator ATA image 254, the PC Card interface 256, and the Media Bay accelerator interface 258, as seen in FIG. 18.

The SCB Media Bay accelerator 242 connects to the PCI bus physically as well as logically, typically as PCI Device Function 1. When the PCI bus driver 228 enumerates this PCI physical device object, and determines that the device object is the Media Bay accelerator driver 242, the bus driver 228 loads the Media Bay accelerator driver 242.

When a media card 20 is plugged in, through an adapter 40,180, the PCMCIA function driver 232 loads the ATA driver 226, which provides a disk storage interface. The ATA driver 226 communicates with the ATA register set that is implemented as an ATA register set image 254 in the Media Bay accelerator function. As seen in FIG. 18, the first device node 222 is the device node for the PCMCIA reader hardware, which is embedded in the SCB MediaBay chip 34.

The operating system for the host system 32, such as a Windows™ operating system, does not know that the SCB media bay 242 comprises the flash media reader logic, since the operating system does not determine that the active electronics reside in the controller 34, and not on the adapter 40,180.

As seen in FIG. 18, the ATA Image provided by the MediaBay Accelerator 242 is accessed by the Windows-provided ATA/ATAPI disk storage stack. The ATA driver 226 is not aware of the back-end processing done by the SCB Media Bay driver 242. The SCB Media Bay driver 242 accesses the ATA image 254, through the Media Bay Accelerator register interface 258. The ATA image 254 can either be accessed by the 10 addresses typically used by the ATA driver 226, or alternately by memory addresses that the SCB MediaBay driver 242 uses, through the accelerator interface 258. Through the ATA image 254, the SCB Media Bay driver 242 obtains ATA-type commands and parameters. The SCB Media Bay driver 242 translates these commands and parameters into new commands and parameters, which are relevant to the flash media interfaces. When the translation is complete, the SCB Media Bay driver 242 communicates the completion to the ATA driver 226, through the shared ATA Image 254.

The MediaBay Accelerator 242 function does not change how the PC Card controller 34 functions in device fit into the Windows PCMCIA software stack, through the PCMCIA bus filter 234 and PC card interface 256.

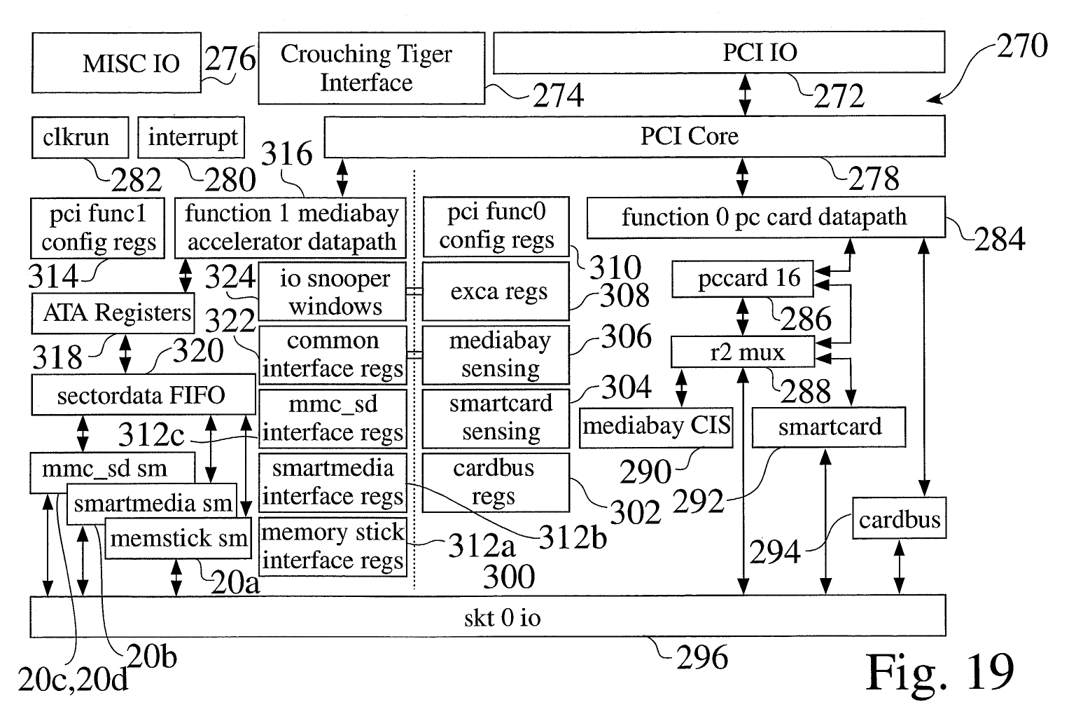

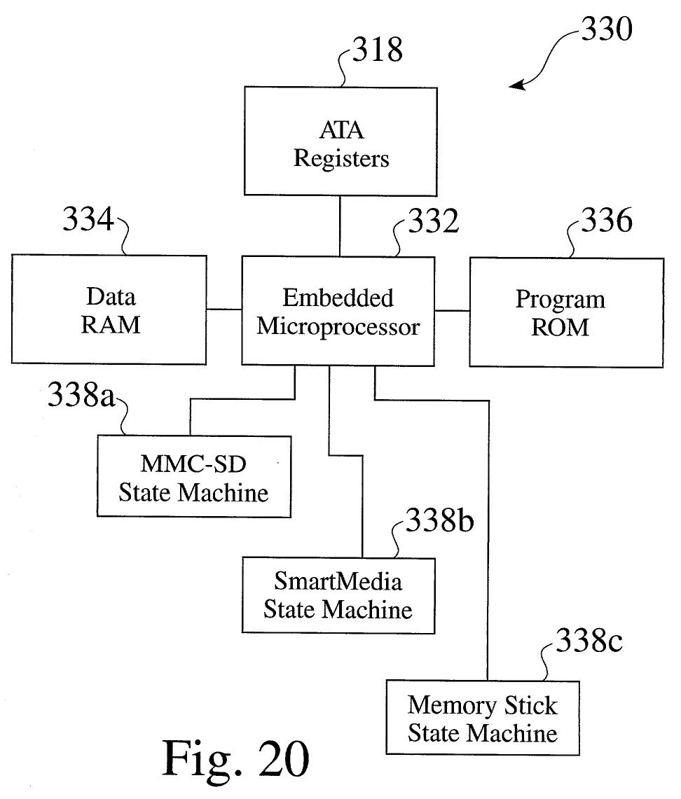

Media Bay Accelerator Hardware Architecture. FIG. 19 is a schematic block diagram of SCB MediaBay accelerator hardware architecture 270. Existing functionality of the operating system typically comprises a PCI I/O 272, Misc I/O 276, and a PCI core 278 in communication with the PCI I/O 272. FIG. 20 is a partial schematic block diagram 330 of an SCB Media Bay system integrated within host hardware architecture.

As seen in FIG. 19, the Media Bay Accelerator 242 comprises MediaBay Accelerator functions, such as PCI func1 configuration registers 314, function1 media bay accelerator data path 316, ATA registers 318, and sector data FIFO 320. The Media Bay Accelerator 242 also comprises common interface registers 322, I/O snooper windows 324, as well as registers 312 for cards 20 having different formats, such as a Memory Stick™ interface register 312a for a connected Memory Stick™ card 20a, a SmartMedia™ interface register 312b for a connected SmartMedia™ card 20b, and/or a MMC/SD interface register.

A MediaBay adapter is reported as a 16-bit PC Card ATA device. In one embodiment of the architecture 270, the MediaBay CIS identifies a Media Bay adapter 40,180 as a standard ATA compatible device, such that the ATA disk driver 226 provided by the operating system is loaded.

The Media Bay accelerator 242 typically comprises a PCI functional enhancement to a microprocessor 332 for a host system 32. A Media Bay accelerator driver 242, referred to as mediabay.sys, is loaded to the operating system. The Media Bay accelerator driver 242 provides the Media Bay accelerator functionality, and handles low-level tasks that the firmware in a typical ATA adapter performs. For example, the Media Bay accelerator 242 handles PCI INTA# interrupts generated by the function, but does not hook into the Windows storage class.

The mediabay.sys driver 242 receives ATA command information through the ATA register set 318, which provides the ATA image 254 to the system. While the PCMCIA system considers access to the ATA registers 318 is provided by function 0 data path 284; the PCI function 1 configuration register 314 is aware of the ExCA windows and window enables 308, and “snoops” or steals 324 the PCI cycles to the ATA registers 318.

The 16-bit PC Card function 0 data path 284 does not claim these cycles, because the data path 284 is designed to disable ExCA windows 0/1 when a Media Bay adapter is inserted. Since the enable bits are set, the operating system believes the PCMCIA controller handles these cycles. Function 1 therefore generates the INTA# required for mediabay.sys 242, and notifies the Function 0 data path 284 when to generate an IRQ request for the standard ATA disk driver.

The Media Bay architecture 270 therefore provides an ATA image in a new PCI Function, even though the operating system the access to the ATA registers 314 is via the PCMCIA function. Since the Media Bay accelerator system 270 is preferably a fully integrated solution, i.e. being integrated with the existing microprocessor and hardware of a host system 32, power management concerns are minimal.

Another advantage of the Media Bay accelerator system 270 is the increased speed of data transfer, since data transfer is performed entirely over the PCI system, thereby avoiding delay inherent to a standard 16-bit PCMCIA path.

As seen in FIG. 19, the Media Bay accelerator system 270 does not require dedicated hardware within a host system, such as a dedicated microprocessor, or associated RAM and ROM, since the system 270 can be implemented with the microprocessor of the host system 32. For example, as seen in FIG. 20, the Media Bay accelerator system 270 is embedded within a host microprocessor 332, having associated data RAM 334, program ROM 336, and ATA registers 318. The embedded Media Bay accelerator system 270 is readily connected to media cards 20, through media state machines 338, such as through an MMC-SD state machine 338a, a Smart media state machine 338b, and/or a Memory Stick state machine 338c.

SCB Media Bay Operation for Flash Media. Upon boot-up of the host system 32, the PCI function, indicated by PCI configuration registers 314, e.g. such as function data path 316 (FIG. 19), and the Media Bay accelerator driver 242 (FIG. 18) are loaded.

SmartMedia, Memory Stick, MMC, or SD Card Insertions. Upon connection of a media card 20 to the host system 32, through a Media Bay flash media adapter, the adapter 40,180 is typically reported as a 3.3V 16-bit PC Card ATA device. CIS details are typically provided by the Media Bay CIS 290, which intercepts attribute memory reads from a Media Bay flash media adapter 40. PCMCIA services 228 then powers the card socket 36, allocates the appropriate EXCA I/O windows, configures the PC card controller 34 to generate the appropriate IRQ, and loads the ATA disk driver 226.

The ATA driver begins I/O accesses to the ATA registers that control flash media storage. These ATA registers are mapped by PCMCIA service using EXCA I/O windows. The Media Bay Accelerator 242 is aware of the ExCA I/O window maps and window enables, and claims, i.e. snoops, or steals, the PCI cycles with the register addresses. The 16-bit PC card function does not claim these cycles, since the PC Card function ignores EXCA windows 0/1 accesses when a Media Bay adapter 40,180 is inserted.

When the ATA command register 318 is written, the Media Bay system 270 generates INTA#, through the Media Bay driver 242. The Media Bay accelerator driver 242 obtains the ATA command information through the ATA register set that provides the ATA image to the system. Command type, e.g. such as Identify Drive, and Read Sector, and parameters are acquired by the Media Bay accelerator driver 242, which handles all lower-level tasks that translate from the ATA-type interface to the flash media interfaces 256. The flash media interfaces 256 are accessed through the Media Bay interface registers 312, which retain all control and status necessary between the driver 242 and the media card 20, such as to determine which type of flash media 20. e.g. a Memory Stick™ card 20a, a Smart Media™ card 20b, an MMC card 20c, or an SD card 20d, is inserted through the card adapter 40,180.

When the ATA command is complete, the Media Bay accelerator driver 242 indicates the completion, through the ATA register image 254, and indicates to the function 0 data path 284 to issue the ATA IRQ interrupt.

The MediaBay Accelerator system 270 provides an ATA image in a new PCI function, while the host operating system considers that the access to the ATA registers is via the PCMCIA function. The MediaBay Accelerator system 270 provides increased speed, since the ATA accesses are handled completely by the PCI, while the relatively slow 16-bit PCMCIA accesses are preferably completely bypassed.

While the passive flash media adapter system 30 is disclosed above as an adapter system for flash media 20, such as Memory Stick™ media 20a, SmartMedia™ media 20b, MMC media 20c, and/or SD media 20c, the adapter system 30 is readily adapted for a wide variety of connections between a host system 32 and external media, such as through a variety of card connections, adapter connections, bus and/or network connections. As well, the adapter system 30 can readily be used for a wide variety of connected media, such as for smart cards, disk or chip based media. Furthermore, the adapter system 30 may readily provide connections to a wide variety of devices or networks. In addition, alternate embodiments of the enhanced PC card controller 34 may provide other enhancements between a host system 32 and external devices 20 connected through the passive adapter 40, such as small form factor IO devices.

Although the passive flash media adapter system and its methods of use are described herein in connection with a personal computers and other microprocessor-based devices, such as the apparatus and techniques can be implemented for a wide variety electronic devices and systems, or any combination thereof, as desired.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

What is claimed is:

1. A process, comprising the steps of:
providing a host system comprising a card controller in communication with a card bay, the card bay comprising one or more connections;
providing an adapter comprising system connections, means for connection to one or more media cards having different formats, and a unique corresponding card detect for each format;
sensing the presence of an installed media card through the adapter connected to the card bay at card controller; and
determining the format of the installed media card at the card controller, based upon the card detects.

2. The process of claim 1, wherein the sensing step is based the card detects.

3. The process of claim 1, wherein at least one of the media cards is a Memory Stick™ card.

4. The process of claim 1, wherein at least one of the media cards is a SmartMedia™ card.

5. The process of claim 1, wherein at least one of the media cards is an MMC card.

6. The process of claim 1, wherein at least one of the media cards is an SD card.

7. The process of claim 1, wherein the step of sensing the presence of an installed media card comprises sampling at least one of the system connections.

8. The process of claim 1, wherein the step of sensing the presence of an installed media card comprises determining a logic state for at least one of the system connections.

9. The process of claim 1, wherein the step of sensing the presence of an installed media card comprises determining a voltage for at least one of the system connections.

10. The process of claim 1, wherein the step of determining the format of the installed media card comprises determining a query logic state associated with the media card format.

11. The process of claim 1, wherein the adapter comprises system connections for simultaneous connections to a plurality media cards having different formats.

12. The process of claim 1, further comprising the step of:
determining that the adapter supports multiple media formats.

13. The process of claim 1, wherein the adapter comprises a manual card insertion mechanism.

14. The process of claim 1, wherein the adapter comprises a manual card removal mechanism.

15. The process of claim 1, wherein the adapter comprises a card ejection mechanism.

16. A process, comprising the steps of:
providing a host system comprising a card controller in communication with a card bay, the card bay comprising one or more connections;
providing an adapter comprising system connections, means for connection to one or more media cards having different formats, and a unique corresponding presence indicator for each format;
sensing the presence of an installed media card through the adapter connected to the card bay at the card controller, based upon the presence indicators; and
determining the format of the installed media card at the card controller.

17. The process of claim 16, wherein the format determination is based upon the presence indicators.

18. A system, comprising:
a host system comprising a card controller in communication with a card bay, the card bay comprising one or more connections;
an adapter comprising system connections, means for connection to one or more media cards having different formats, and a unique corresponding card detect for each format;
means for sensing the presence of an installed media card through the adapter connected to the card bay at card controller; and
means for determining the format of the installed media card at the card controller, based upon the card detects.

19. The system of claim 18, wherein the sensing step is based upon the card detects.

20. The system of claim 18, wherein at least one of the media cards is a Memory Stick™ card.

21. The system of claim 18, wherein at least one of the media cards is a SmartMedia™ card.

22. The system of claim 18, wherein at least one of the media cards is an MMC card.

23. The system of claim 18, wherein at least one of the media cards is an SD card.

24. The system of claim 18, wherein the sensing means comprises a means for sampling at least one of the system connections.

25. The system of claim 18, wherein the sensing means comprises a logic state for at least one of the system connections.

26. The system of claim 18, wherein sensing means comprises a voltage state for at least one of the system connections.

27. The system of claim 18, wherein the format determination means comprises a query logic state associated with the media card format.

28. The system of claim 18, wherein the adapter comprises system connections for simultaneous connections to a plurality media cards having different formats.

29. The system of claim 18, further comprising:
means for determining if the adapter supports multiple media formats.

30. The system of claim 18, wherein the adapter comprises a manual card insertion mechanism.

31. The system of claim 18, wherein the adapter comprises a manual card removal mechanism.

32. The system of claim 18, wherein the adapter comprises a card ejection mechanism.

33. A system, comprising:
a host system comprising a card controller in communication with a card bay, the card bay comprising one or more connections;
an adapter comprising system connections, means for connection to one or more media cards having different formats, and a unique corresponding presence indicator for each format;
means for sensing the presence of an installed media card through the adapter connected to the card bay at card controller, based upon the presence indicators; and
means for determining the format of the installed media card at the card controller.

34. The system of claim 33, wherein the format determination step is based upon the presence indicators.

35. An apparatus, comprising:
an adapter body comprising a card socket region defined therein for alternatively receiving a single media card of a plurality of media cards having different card formats, the card socket region extending into the adapter body to a common back wall;
a plurality of contact regions located within the card socket region, each of the contact regions associated one or more of a plurality of media formats; and
a plurality of system contacts associated with the contact regions.

36. The apparatus of claim 35, wherein the single media card is a SmartMedia™ card.

37. The apparatus of claim 35, wherein the single media card is an MMC card.

38. The apparatus of claim 35, wherein the single media card is an SD card.

39. The apparatus of claim 35, wherein the plurality of media formats comprises a SmartMedia™ format, an MMC format, and an SD format.

40. The apparatus of claim 35, wherein the different card formats comprise unique card housings.

41. The apparatus of claim 35, wherein the media formats comprise card contacts associated with the contact regions within the card socket.

42. A card socket adapter, comprising:
an adapter body comprising a card socket region defined therein for alternatively receiving a single media card of a plurality of media cards comprising a SmartMedia™ format, an MMC format, and an SD format, the card socket region extending into the adapter body to a common back wall;
a first contact region located within the card socket region for providing contact with a media card chosen from the group of an MMC and an SD card;
a second contact region located within the card socket region for providing contact with a SmartMedia™ card; and
a plurality of system contacts associated with the first contact region and the second contact region.

43. The apparatus of claim 42, wherein the single media card is a SmartMedia™ card.

44. The apparatus of claim 42, wherein the single media card is an MMC card.

45. The apparatus of claim 42, wherein the single media card is an SD card.

46. The apparatus of claim 42, wherein the adapter body further comprises a front face, and wherein the card socket region extends to a common back wall by a defined insertion depth, such that a received media card of any of the plurality of media cards extends into the card socket region to the common back wall.

47. The apparatus of claim 42, wherein the different card formats comprise unique card housings.

48. The apparatus of claim 42, wherein the media formats comprise card contacts associated with the contact regions within the card socket.

49. A system, comprising:
a microprocessor;
an external driver associated with the microprocessor;
a media bay for connection to at least one media card; and
a media bay driver associated with the microprocessor, the media bay driver in communication with the media bay and with the external driver, the media bay driver adapted to translate external driver operating parameters to media bay operating parameters.

50. The system of claim 49, wherein the external driver is an ATA disk storage stack.

51. The system of claim 49, wherein the media card is a SmartMedia™ card.

52. The system of claim 49, wherein the media card is an MMC card.

53. The system of claim 49, wherein the media card is an SD card.

54. The system of claim 49, wherein the media bay driver further comprises means for determining format of a media card connected to the passive adapter.

55. The system of claim 49, further comprising:
a passive adapter connectable between the media bay and the media card.

56. The system of claim 49, wherein the media bay driver further comprises means for determining format of a media card connected to the passive adapter.
